(19) United States
(12) Patent Application Publication
(10) Pub. No.: US 2026/0302109 A1
(43) Pub. Date: Oct. 1, 2026

(54) REED SENSOR WITH WRAP-BACK SWITCH DESIGN

(71) Applicant: Dongguan Littelfuse Electronics Company Limited, Dongguan City (CN)

(72) Inventors: Jowell Xiao, Dongguan City (CN); Jia Huang, Dongguan City (CN); Tom Yu, Huizhou City (CN)

(73) Assignee: Dongguan Littelfuse Electronics Company Limited, Dongguan City (CN)

(21) Appl. No.: 19/577,725

(22) Filed: Mar. 25, 2026

(30) Foreign Application Priority Data
Mar. 28, 2025 (CN) 202510387362.9

(51) Int. Cl. H01H 36/00; H01H 9/02

(52) U.S. Cl. CPC H01H 36/00; H01H 9/02

(57) ABSTRACT

Disclosed is a switching assembly including a housing having a first chamber and a second chamber, and a reed switch comprising a capsule within the first chamber of the housing. The reed switch may further include a first lead and a second lead each extending from the capsule, wherein the first lead extends between the first chamber and the second chamber.

### CROSS-REFERENCE TO RELATED APPLICATIONS

This application claims the benefit of priority to, Chinese Patent Application No. 202510387362.9, filed Mar. 28, 2025, entitled “REED SENSOR WITH WRAP-BACK SWITCH DESIGN,” which application is incorporated herein by reference in its entirety.

### FIELD OF THE DISCLOSURE

Embodiments relate to the field of circuit protection devices and, more particularly, to a reed sensor with wrap-back switch design.

### BACKGROUND OF THE DISCLOSURE

Reed switches are electromechanical switches having two reed blades formed of a conductive material. In the presence of a magnetic field, the overlapping reed blades attract, causing the blades to bend towards each other and make contact, thus closing an electrical circuit. The two reed blades may be positioned within a glass capsule hermetically sealing a portion of each of the reed blades. The capsule typically contains a vacuum, air, or nitrogen at atmospheric or super atmospheric pressure. Reed switches can switch significant power, for example in the range of 10 to 100 Watts. Reed switches also have a long life measured in millions to over 100 million operations without failure or significant increase in contact resistance.

However, current reed switch designs have space limitations during assembly. Furthermore, a soldering joint of the switch is only a short distance from the capsule end, which causes the soldering joint to be exposed, potentially leading to failures.

Still furthermore, with current reed switch designs, an activation distance and a deactivation distance varies due to the switch being off-centered. That is, a gap between the switch and the magnet changes depending on direction of activation, which may lead to inconsistent results.

It is with respect to this and other deficiencies of the prior art that the present disclosure is provided.

### SUMMARY OF THE DISCLOSURE

The Summary is provided to introduce a selection of concepts in a simplified form, the concepts further described below in the Detailed Description. The Summary is not intended to identify key features or essential features of the claimed subject matter, nor is the Summary intended as an aid in determining the scope of the claimed subject matter.

In one approach, a switching assembly may include a housing having a first chamber and a second chamber, and a reed switch including a capsule within the first chamber of the housing. The reed switch may further include a first lead and a second lead each extending from the capsule, wherein the first lead extends between the first chamber and the second chamber.

In another approach, a reed switch may include a housing having a first chamber and a second chamber, and a capsule within the first chamber of the housing. The reed switch may further include a first lead and a second lead each extending from the capsule, wherein the first lead extends between the first chamber and the second chamber.

In yet another approach, a circuit protection device may include a housing having a first chamber and a second chamber, and a reed switch comprising a capsule within the first chamber of the housing. The reed switch may further include a first lead and a second lead each extending from the capsule, wherein the first lead comprises a first section extending through the first chamber, a second section extending through the second chamber, and a third section connecting the first and second sections.

### BRIEF DESCRIPTION OF THE DRAWINGS

The accompanying drawings illustrate exemplary approaches of the disclosed embodiments so far devised for the practical application of the principles thereof, and wherein:

FIG. 1A is a perspective view of a circuit protection device according to embodiments of the present disclosure;

FIG. 1B is a side cutaway view of the circuit protection device according to embodiments of the present disclosure;

FIG. 1C is an end view of the circuit protection device according to embodiments of the present disclosure;

FIG. 2 is a perspective view of a housing of the circuit protection device according to embodiments of the present disclosure; and

FIG. 3 is a top view of a passageway of the housing of the circuit protection device according to embodiments of the present disclosure.

The drawings are not necessarily to scale. The drawings are merely representations, not intended to portray specific parameters of the disclosure. The drawings are intended to depict exemplary embodiments of the disclosure, and therefore are not to be considered as limiting in scope. In the drawings, like numbering represents like elements.

Furthermore, certain elements in some of the figures may be omitted, or illustrated not-to-scale, for illustrative clarity. The cross-sectional views may be in the form of "slices", or "near-sighted" cross-sectional views, omitting certain background lines otherwise visible in a "true" cross-sectional view, for illustrative clarity. Furthermore, for clarity, some reference numbers may be omitted in certain drawings.

### DETAILED DESCRIPTION

Assemblies, devices, and switches in accordance with the present disclosure will now be described more fully hereinafter with reference to the accompanying drawings, where embodiments are shown. The assemblies, devices, and switches may be embodied in many different forms and are not to be construed as being limited to the embodiments set forth herein. Instead, these embodiments are provided so the disclosure will be thorough and complete, and will fully convey the scope of the disclosure to those skilled in the art.

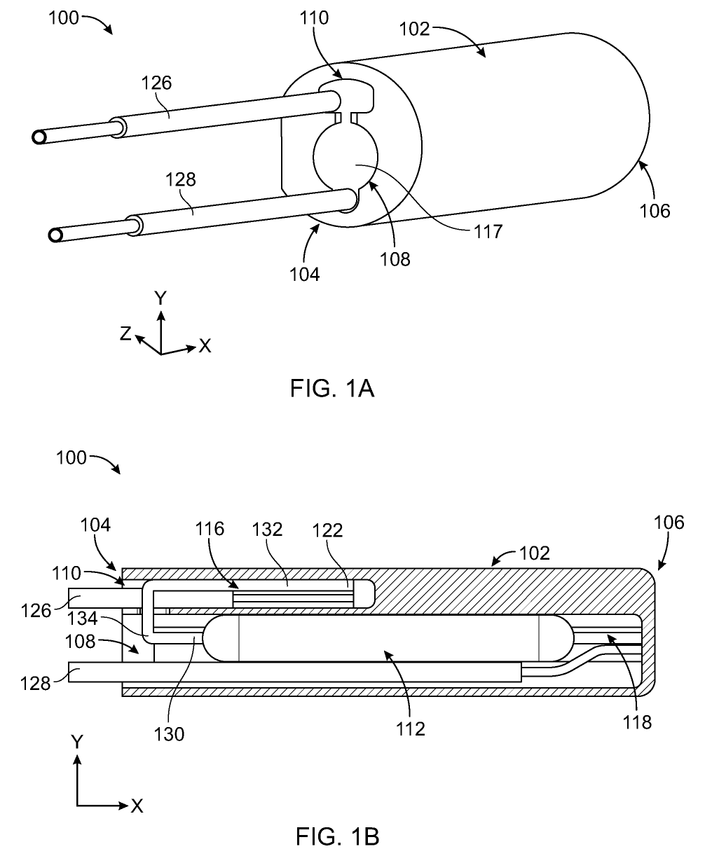

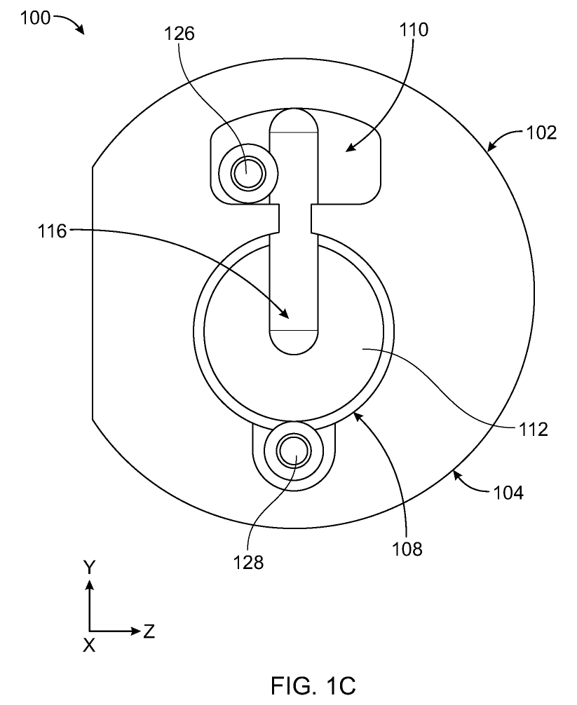

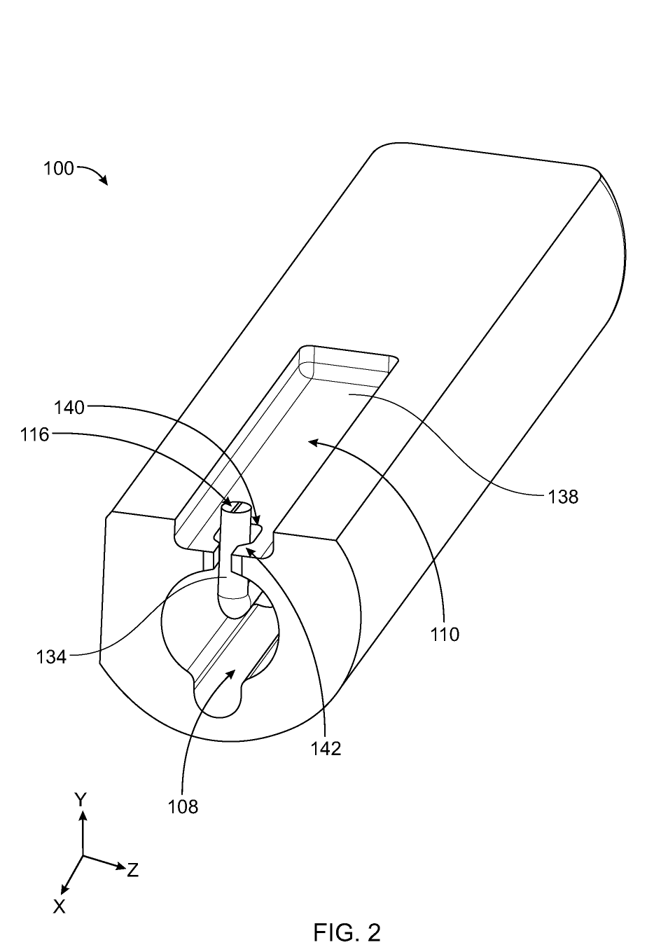

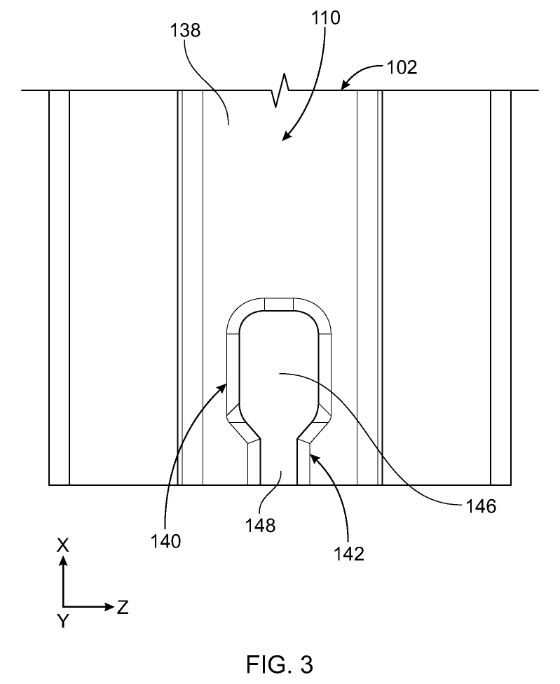

FIGS. 1A – 1C demonstrate a circuit protection device (hereinafter “device”) 100, such as a reed switch, according to embodiments of the present disclosure. As shown, the device 100 may include a housing 102 having a first end 104 opposite a second end 106. Within the housing 102 may be a first chamber 108 adjacent a second chamber 110. Although not limited to any particular shape, size, or configuration, the first chamber 108 and the second chamber 110 may each generally be a hollow channel. As best shown in FIG. 1B, the first chamber 108 may be open at the first end 104 of the housing 102, and may extend between the first end 104 and the second end 106. The second chamber 110 may also be open at the first end 104, but may extend only partially between the first end 104 and the second end 106. As shown in FIG. 1A, an insulative material 117 (e.g., an epoxy) may be present within the first and second chambers 108, 110. The particular exterior shape and/or configuration of the exterior of the housing 102 is not intended as limiting.

The device 100 may include a capsule 112 within the first chamber 108 of the housing, wherein a first lead 116 and a second lead 118 extend outside the capsule 112. Although not shown, two reed blades may be located within capsule 112.

The first lead 116 may include a free end 122 extending within the second chamber 110, the free end 122 representing a solder point with a first electrical conduit 126 (e.g., wire) extending within the second chamber 110. A second electrical conduit 128 may extend within the first chamber 108 for connection with the second lead 118. The second electrical conduit 128 may extend entirely to the second end 106 of the housing 102.

In some embodiments, the first lead 116 may include a first section 130 extending from the capsule 112, wherein the first section 130 is positioned within the first chamber 108, and a second section 132 positioned with the second chamber 110. A third section 134 connects the first and second sections 130, 132. Although not limited to any particular shape or configuration, the first and second sections 130, 132 may extend substantially parallel to one another, while the third section 134 may extend substantially perpendicular to the first and second sections 130, 132. As arranged, the first lead 116 “wraps-back,” or has a U-shaped configuration.

Referring to FIGS. 2 – 3, the housing 102 will be described in greater detail. As shown, the first chamber 108 and the second chamber 110 may be separated from one another by a wall 138. Through the wall 138 may be a passageway 140, wherein the first lead 116 is permitted to extend through the passageway 140. More specifically, the third section 134 of the first lead 116 may be positioned through a main opening 146 of the passageway 140. However, a narrowed neck area 142 partially defining the passageway 140 prevents the first lead 116 from significantly moving, e.g., in the x-direction. In some embodiments, the narrowed neck area 142 may include a slit 148 extending between the main opening 146 and the first end 106 of the housing 102. Advantageously, the passageway 140 acts as a keyhole feature for alignment of the first lead 116.

As used herein, an element or step recited in the singular and proceeded with the word “a” or “an” is understood as not excluding plural elements or steps, unless such exclusion is explicitly recited. Furthermore, references to “one embodiment” of the present disclosure are not intended to be interpreted as excluding the existence of additional embodiments also incorporating the recited features.

The use of “including,” “comprising,” or “having” and variations thereof herein is meant to encompass the items listed thereafter and equivalents thereof as well as additional items. Accordingly, the terms “including,” “comprising,” or “having” and variations thereof are open-ended expressions and can be used interchangeably herein.

The phrases “at least one”, “one or more”, and “and/or”, as used herein, are open-ended expressions and are both conjunctive and disjunctive in operation. For example, expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

All directional references (e.g., proximal, distal, upper, lower, upward, downward, left, right, lateral, longitudinal, front, back, top, bottom, above, below, vertical, horizontal, radial, axial, clockwise, and counterclockwise) are just used for identification purposes to aid the reader's understanding of the present disclosure. The directional references do not create limitations, particularly as to the position, orientation, or use of the disclosure. Connection references (e.g., attached, coupled, connected, and joined) are to be construed broadly and may include intermediate members between a collection of elements and relative movement between elements unless otherwise indicated. As such, connection references do not necessarily infer two elements are directly connected and in fixed relation to each other.

Furthermore, identification references (e.g., primary, secondary, first, second, third, fourth, etc.) are not intended to connote importance or priority, and are used to distinguish one feature from another. The drawings are for purposes of illustration, and the dimensions, positions, order and relative sizes reflected in the drawings attached hereto may vary.

Furthermore, the terms “substantial” or “approximately,” as well as the terms “approximate” or “approximately,” can be used interchangeably in some embodiments, and can be described using any relative measures acceptable by one of ordinary skill in the art. For example, these terms can serve as a comparison to a reference parameter, to indicate a deviation capable of providing the intended function. Although non-limiting, the deviation from the reference parameter can be, for example, in an amount of less than 1%, less than 3%, less than 5%, less than 10%, less than 15%, less than 20%, and so on.

While certain embodiments of the disclosure have been described herein, the disclosure is not limited thereto, as the disclosure is as broad in scope as the art will allow and the specification may be read likewise. Therefore, the above description is not to be construed as limiting. Instead, the above description is merely as exemplifications of particular embodiments. Those skilled in the art will envision other modifications within the scope and spirit of the claims appended hereto.

What is claimed is:

1. A switching assembly, comprising:
a housing including a first chamber and a second chamber; and
a reed switch comprising a capsule within the first chamber of the housing, the reed switch further comprising a first lead and a second lead each extending from the capsule, wherein the first lead extends between the first chamber and the second chamber.

2. The switching assembly of claim 1, wherein the first lead includes a free end, and wherein the free end terminates within the second chamber.

3. The switching assembly of claim 2, wherein the first lead is connected with a first electrical conduit.

4. The switching assembly of claim 3, wherein the first electrical conduit extends within the second chamber, and wherein a second electrical conduit extends within the first chamber.

5. The switching assembly of claim 1, further comprising an insulative material within the first chamber and the second chamber.

6. The switching assembly of claim 1, wherein the housing further comprises a wall separating the first chamber and the second chamber.

7. The switching assembly of claim 6, further comprising a passageway through the wall, wherein the first lead extends through the passageway.

8. The switching assembly of claim 6, wherein the passageway is defined in part by a neck area, and wherein the neck area restricts movement of the first lead.

9. A reed switch, comprising:
a housing including a first chamber and a second chamber;
a capsule within the first chamber of the housing; and
a first lead and a second lead each extending from the capsule, wherein the first lead extends between the first chamber and the second chamber.

10. The reed switch of claim 9, wherein the first lead includes a free end, and wherein the free end terminates within the second chamber.

11. The reed switch of claim 10, wherein the first lead is connected with a first electrical conduit, wherein the first electrical conduit extends within the second chamber, and wherein a second electrical conduit extends within the first chamber.

12. The reed switch of claim 9, further comprising an insulative material within the first chamber and the second chamber.

13. The reed switch of claim 9, wherein the housing further comprises a passageway connecting the first chamber and the second chamber, and wherein the first lead extends through the passageway.

14. The reed switch of claim 13, wherein the passageway is defined in part by a neck area, and wherein the neck area restricts movement of the first lead.

15. A circuit protection device, comprising:
a housing including a first chamber and a second chamber; and
a reed switch comprising a capsule within the first chamber of the housing, the reed switch further comprising a first lead and a second lead each extending from the capsule, wherein the first lead comprises a first section extending through the first chamber, a second section extending through the second chamber, and a third section connecting the first and second sections.

16. The circuit protection device of claim 15, wherein the second section of the first lead includes a free end, and wherein the free end terminates within the second chamber.

17. The circuit protection device of claim 16, wherein the free end is connected with a first electrical conduit, wherein the first electrical conduit extends within the second chamber, and wherein a second electrical conduit extends within the first chamber.

18. The circuit protection device of claim 15, further comprising an insulative material within the first chamber and the second chamber.

19. The circuit protection device of claim 15, wherein the housing further comprises a passageway connecting the first chamber and the second chamber, and wherein the third section of the first lead extends through the passageway.

20. The circuit protection device of claim 19, wherein the passageway is defined in part by a neck area, and wherein the neck area restricts movement of the third section of the first lead.
